(19) United States
(12) Patent Application Publication
(10) Pub. No.: US 2014/0088287 A1
(43) Pub. Date: Mar. 27, 2014

(54) PRODUCTION METHOD FOR LIQUID CRYSTAL POLYESTER

(71) Applicants: Kiichiro Nishimura, Chiyoda-ku (JP); Lu Shi, Chiyoda-ku (JP); Satoshi Murouchi, Chiyoda-ku (JP)

(72) Inventors: Kiichiro Nishimura, Chiyoda-ku (JP); Lu Shi, Chiyoda-ku (JP); Satoshi Murouchi, Chiyoda-ku (JP)

(73) Assignee: JX NIPPON OIL & ENERGY CORPORATION, Tokyo (JP)

(21) Appl. No.: 14/111,035

(22) PCT Filed: Apr. 12, 2012
(86) PCT No.: PCT/JP2012/060075

§ 371 Date: Dec. 16, 2013

(30) Foreign Application Priority Data
Apr. 15, 2011 (JP) 2011-091591

(51) Int. Cl. C08G 63/80

(52) U.S. Cl. CPC C08G 63/80
USPC 528/302

(57) ABSTRACT

A method for producing a liquid crystal polyester according to the present invention is a method for producing a liquid crystal polyester, comprising subjecting a composition in which a dicarboxylic acid compound, a hydroxycarboxylic acid compound, and a dihydroxy compound are contained to melt polycondensation, and subjecting an obtained reaction product to solid phase polycondensation, wherein the composition contains, based on a total of the dicarboxylic acid compound, the hydroxycarboxylic acid compound, and the dihydroxy compound, 2 to 30 mole % of a dicarboxylic acid compound represented by the following formula (1), and 40 to 80 mole % of p-hydroxybenzoic acid, a polycondensation temperature of the above melt polycondensation is 315° C. or less, and a polycondensation temperature of the above solid phase polycondensation is 315° C. or less.

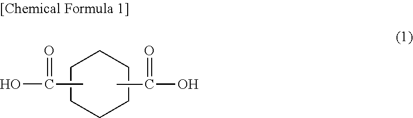

### TECHNICAL FIELD

The present invention relates to a method for producing a liquid crystal polyester.

### BACKGROUND ART

In recent years, materials excellent in heat resistance, mechanical properties, chemical resistance, and the like have been required for fibers, films, molded articles, or the like. As materials coping with them, liquid crystalline polymers have attracted attention. As one type thereof, there is a liquid crystal polyester produced by polycondensing a dicarboxylic acid compound containing an aromatic dicarboxylic acid and a dihydroxy compound containing an aromatic diol.

For the composition of liquid crystal polyesters, studies aimed at improvements in polymer properties have been made so far. For example, for the purpose of improving the mechanical properties of liquid crystal polyesters, liquid crystal polyesters containing hydroxycarboxylic acid compounds, such as p-hydroxybenzoic acid, and a cyclohexanedicarboxylic acid component have been proposed (for example, see the following Patent Literature 1).

### CITATION LIST

### Patent Literature

Patent Literature 1: Japanese Patent Application Laid-Open No. 2-004822

### SUMMARY OF INVENTION

### Technical Problem

The liquid crystal polyester as described above is usually produced by melt polycondensation in which raw material monomers are charged into a reaction container, and heated and melted to allow a polycondensation reaction to proceed while stirring and mixing. In such melt polycondensation, due to an increase in the degree of polymerization (molecular weight) accompanied by proceeding of the reaction, the melting point of the polymer increases, and therefore, it is necessary to increase the reaction temperature in order to allow the reaction to proceed uniformly while maintaining the molten state.

But, when the degree of polymerization is increased in the above step in order to ensure heat resistance and mechanical properties, the liquid crystal polyester is easily discolored to turn into brown due to the thermal history.

The present invention has been made in view of the above circumstances, and it is an object of the present invention to provide a method for producing a liquid crystal polyester in which a liquid crystal polyester having sufficient heat resistance and mechanical properties and having sufficiently suppressed discoloration.

### Solution to Problem

In order to solve the above problem, the present inventors have studied diligently, and, as a result, found that a liquid crystal polyester with sufficiently suppressed discoloration while having sufficient heat resistance and mechanical properties is obtained by subjecting a composition containing specific compounds to melt polycondensation at a specific temperature and subjecting the obtained reaction product to solid phase polycondensation at a specific temperature, leading to the completion of the present invention.

A method for producing a liquid crystal polyester according to the present invention is a method for producing a liquid crystal polyester, comprising subjecting a composition in which a dicarboxylic acid compound, a hydroxycarboxylic acid compound, and a dihydroxy compound are contained to melt polycondensation, and subjecting an obtained reaction product to solid phase polycondensation, wherein the composition contains, based on a total of the dicarboxylic acid compound, the hydroxycarboxylic acid compound, and the dihydroxy compound, 2 to 30 mole % of a dicarboxylic acid compound represented by the following formula (1), and 40 to 80 mole % of p-hydroxybenzoic acid, a polycondensation temperature of the melt polycondensation is 315° C. or less, and a polycondensation temperature of the solid phase polycondensation is 315° C. or less.

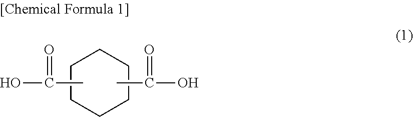

According to the method for producing a liquid crystal polyester according to the present invention, which has the above configuration, a liquid crystal polyester having good color with sufficiently suppressed discoloration while having sufficient heat resistance and mechanical properties can be obtained. The present inventors consider the reason why such an effect can be obtained, as follows. It is considered that by first performing the melt polycondensation of the above specific composition to a low degree of polymerization while reducing the temperature in the above temperature range, the stirring of the melt (liquid) becomes easy, and variations in the degree of polymerization can be suppressed. It is considered that by then subjecting the reaction product in which the degree of polymerization is uniform to solid phase polycondensation, a polymer having a degree of polymerization in which heat resistance and mechanical properties are sufficiently ensured can be advantageously obtained even if the temperature is reduced in the above temperature range, and discoloration can also be sufficiently suppressed.

In an LED (light-emitting diode) light-emitting apparatus, a reflector (white reflective frame) is provided around an LED device in order to increase the light utilization rate of the LED. As a molding material for an LED reflector, a liquid crystal polyester resin composition in which a liquid crystal polyester and a white pigment, such as titanium oxide, are blended may be used. For this application, when the degree of discoloration of the liquid crystal polyester is large, it is necessary to increase the amount of the white pigment blended in order to sufficiently ensure the light reflectance of the reflector. In addition, the increase in the amount of the white pigment blended may affect the physical properties of the reflector. On the other hand, in the method for producing a liquid crystal polyester according to the present invention, a liquid crystal polyester with further suppressed discoloration while having sufficient mechanical properties and heat resistance can be obtained by using the specific composition and adjusting the reaction temperature in melt polycondensation and solid phase polycondensation as described above. By using the liquid crystal polyester obtained by the method according to the present invention, sufficient light reflectance can be obtained without increasing the amount of the white pigment blended or even if reducing the amount of it, and it is easy to obtain a molded body that satisfies light resistance, mechanical properties, and heat resistance at higher levels.

In addition, the present inventors have obtained findings that in a case where a liquid crystal polyester is used in the above application, the liquid crystal polyester obtained by the method according to the present invention brings not only sufficient light reflectance for light having a wavelength of 480 nm, but also little discoloration due to light generated from the device of the LED, which result in that the light reflectance is less likely to decrease.

In the method for producing a liquid crystal polyester according to the present invention, in terms of the development of liquid crystallinity during melting, and heat resistance, it is preferable that the composition contains, based on the total of the dicarboxylic acid compound, the hydroxycarboxylic acid compound, and the dihydroxy compound, 10 to 30 mole % of the dicarboxylic acid compound represented by the formula (1), 40 to 80 mole % of p-hydroxybenzoic acid, and 10 to 30 mole % of an aromatic dihydroxy compound represented by the following formula (2).

[Chemical Formula 2]

HO—X—OH (2)

in the formula (2), wherein X represents a divalent group having an aromatic ring.

In addition, in terms of heat resistance and molding processability, it is preferable that the liquid crystal polyester contains 2 to 29 mole % of the dicarboxylic acid compound represented by the formula (1), 40 to 80 mole % of p-hydroxybenzoic acid, 10 to 30 mole % of an aromatic dihydroxy compound represented by the following formula (2), and 1 to 28 mole % of an aromatic dicarboxylic acid compound represented by the following formula (3), and contains 1 mole % or more of isophthalic acid as the aromatic dicarboxylic acid compound represented by the above formula (3).

[Chemical Formula 3]

HO—X—OH (2)

in the formula (2), wherein X represents a divalent group having an aromatic ring.

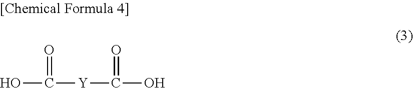

in the formula (3), wherein Y represents a divalent group having an aromatic ring.

### Advantageous Effects of Invention

According to the present invention, it is possible to provide a method for producing a liquid crystal polyester in which a liquid crystal polyester having sufficient heat resistance and mechanical properties and having sufficiently suppressed discoloration can be obtained.

### DESCRIPTION OF EMBODIMENTS

A method for producing a liquid crystal polyester (hereinafter sometimes referred to as an “LCP”) in this embodiment comprises the first step of subjecting a composition in which a dicarboxylic acid compound, a hydroxycarboxylic acid compound, and a dihydroxy compound are contained to melt polycondensation, and the second step of subjecting the reaction product obtained in the first step to solid phase polycondensation.

First, the composition that is a raw material of a liquid crystal polyester and is subjected to the melt polycondensation in the first step will be described.

The composition according to this embodiment contains, based on the total of the dicarboxylic acid compound, the hydroxycarboxylic acid compound, and the dihydroxy compound, 2 to 30 mole % of a dicarboxylic acid compound represented by the following formula (1), and 40 to 80 mole % of p-hydroxybenzoic acid.

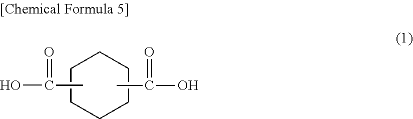

Examples of the dicarboxylic acid compound represented by the above formula (1) include 1,3-cyclohexanedicarboxylic acid and 1,4-cyclohexanedicarboxylic acid. One of these can be used alone, or two of these can be used in combination.

If the content of the dicarboxylic acid compound represented by the above formula (1) in the composition is less than 2 mole %, sufficient mechanical properties and light resistance performance are not attained, and if the content is more than 30 mole %, sufficient heat resistance and molding processability are not attained. In terms of the balance of light resistance, mechanical properties, heat resistance, and molding processability, the content of the dicarboxylic acid compound represented by formula (1) is preferably 5 to 25 mole %, more preferably 15 to 20 mole %, based on the total of the dicarboxylic acid compound, the hydroxycarboxylic acid compound, and the dihydroxy compound.

In this embodiment, in terms of obtaining an LCP having sufficient heat resistance and mechanical properties and having sufficiently suppressed discoloration, it is preferable that the composition contains 5 to 25 mole % of 1,4-cyclohexanedicarboxylic acid based on the total of the dicarboxylic acid compound, the hydroxycarboxylic acid compound, and the dihydroxy compound.

If the content of p-hydroxybenzoic acid in the composition is less than 40 mole %, sufficient molding processability and heat resistance are not attained, and if the content is more than 80 mole %, sufficient molding processability and heat resistance are not attained. In terms of improving both of molding processability and heat resistance, the content of p-hydroxybenzoic acid is preferably 50 to 70 mole %, more preferably 60 to 70 mole %, based on the total of the dicarboxylic acid compound, the hydroxycarboxylic acid compound, and the dihydroxy compound.

The composition can further contain an aromatic dihydroxy compound represented by the following formula (2) or an aromatic dihydroxy compound represented by the following formula (2) and an aromatic dicarboxylic acid compound represented by the following formula (3).

[Chemical Formula 6]

HO—X—OH (2)

in the formula (2), wherein X represents a divalent group having an aromatic ring.

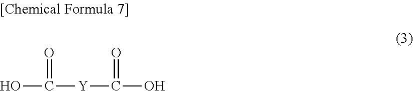

in the formula (3), wherein Y represents a divalent group having an aromatic ring.

When the composition contains the aromatic dihydroxy compound represented by the formula (2) or the aromatic dicarboxylic acid compound represented by the formula (3), one can be used, or two or more can be used in combination for each of the compound represented by formula (2) and the compound represented by formula (3).

Examples of the compounds represented by the formulas (2) and (3) include compounds represented by the following formulas (2-1) and (3-1), respectively.

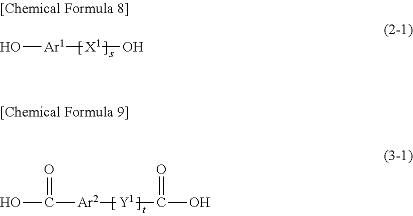

In the formulas (2-1) and (3-1), Ar¹ and Ar² each represent a divalent aromatic group, X¹ and Y¹ each represent a divalent group having an aromatic ring, and s and t each represent an integer of 0 or 1.

As Ar¹ and Ar², a divalent aromatic group represented by the following formula (Ar-1) or (Ar-2) is preferable in terms of heat resistance and molding processability. Two bonds of the benzene ring represented by formula (Ar-1) are in a meta or para relationship.

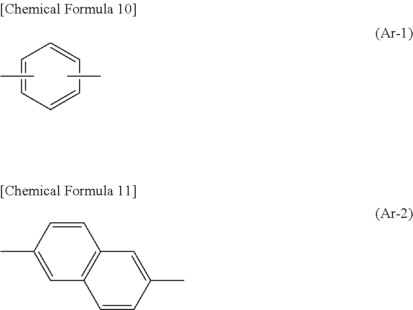

Examples of X¹ include divalent groups represented by the following formula (2-2).

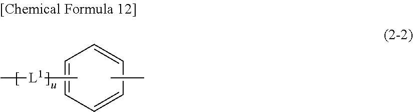

In the formula (2-2), L¹ represents a divalent hydrocarbon group, —O—, —S—, —CO—, —SO—, or —SO₂—, and u represents an integer of 0 or 1. Examples of the divalent hydrocarbon group include alkanediyl groups having 1 to 3 carbon atoms, and among them, —C(CH₃)₂— or —CH(CH₃)— is preferable. Two bonds of the benzene ring in formula (2-2) are in a meta or para relationship.

Examples of Y¹ include divalent groups represented by the following formula (3-2).

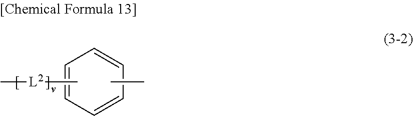

In the formula (3-2), L² represents a divalent hydrocarbon group, —O—, —S—, —SO—, —CO—, or —SO₂—, and v represents an integer of 0 or 1. Examples of the divalent hydrocarbon group include alkanediyl groups having 1 to 3 carbon atoms, and among them, —C(CH₃)₂— or —CH(CH₃)— is preferable. Two bonds of the benzene ring in formula (3-2) are in a meta or para relationship.

When the composition further contains the compound represented by the formula (2), the content of the compound represented by formula (1), p-hydroxybenzoic acid, and the compound represented by formula (2) can be set so that their total is 100 mole % and also the content of the compound of formula (1) and the content of the compound of formula (2) are equal.

Specifically, a composition containing 10 to 30 mole % of the compound represented by the formula (1), 40 to 80 mole % of p-hydroxybenzoic acid, and 10 to 30 mole % of the compound represented by the formula (2) (hereinafter sometimes referred to as a first composition) can be subjected to melt polycondensation.

Specific examples of the compound represented by the formula (2) include hydroquinone, 4,4′-dihydroxybiphenyl, 4,4′-dihydroxybenzophenone, 2,6-naphthalenediol, 4,4′-isopropylidenediphenol, and bisphenol S. One of these can be used alone, or two or more of these can be used in combination.

It is preferable that the first composition contains 15 to 25 mole % of 4,4′-dihydroxybiphenyl as the compound represented by the above formula (2).

When the composition further contains the compound represented by formula (2) and the compound represented by formula (3), the content of the compound represented by formula (1), p-hydroxybenzoic acid, the compound represented by formula (2), and the compound represented by formula (3) can be set so that their total is 100 mole % and also the total of the content of the compound of formula (1) and the compound of formula (3) are equal to the content of the compound of formula (2).

Specifically, a composition containing 2 to 29 mole % of the compound represented by the formula (1), 40 to 80 mole % of p-hydroxybenzoic acid, 10 to 30 mole % of the compound represented by the formula (2), and 1 to 28 mole % of the compound represented by the formula (3) (hereinafter sometimes referred to as a second composition) can be subjected to melt polycondensation.

Specific examples of the compound represented by the above formula (3) include terephthalic acid, isophthalic acid, 2,6-naphthalenedicarboxylic acid, 4,4′-biphenyldicarboxylic acid, and benzophenone-4,4′-dicarboxylic acid. One of these can be used alone, or two or more of these can be used in combination.

In the second composition, it is preferable to contain 1 to 5 mole % of isophthalic acid in the composition in terms of molding processability and heat resistance.

In addition, it is preferable to contain 10 to 20 mole % of 1,4-cyclohexanedicarboxylic acid in the second composition in terms of light resistance and heat resistance. Further, it is preferable to contain 15 to 20 mole % of 4,4′-dihydroxybiphenyl in terms of molding processability and heat resistance.

In the method in this embodiment, the first step of subjecting the above-described composition to melt polycondensation is performed. At this time, in order to shorten melt polycondensation time and reduce the effect of the thermal history during the first step, it is preferable to perform melt polycondensation after previously acetylating the hydroxyl groups of the monomers. Further, in order to simplify the first step, it is preferable that the acetylation is performed by feeding acetic anhydride to the monomers in a reaction vessel, and it is preferable to perform such acetylation step using the same reaction vessel as the melt polycondensation step. In other words, it is preferable to perform the acetylation reaction of the raw material monomers with acetic anhydride in a reaction vessel and, after the completion of the acetylation reaction, increase the temperature for transition to a polycondensation reaction. In addition, it is preferable that acetic anhydride is fed in excess of 1 to 10 mole % of acetic anhydride with respect to the number of moles of the hydroxyl groups of the monomers. If the excessive amount of acetic anhydride is less than 1 mole %, there is a tendency that the reaction rate is slow and the LCP is discolored, and if the excessive amount of acetic anhydride is more than 10 mole %, there is a tendency that the LCP is discolored by the effect of residual acetic anhydride.

The acetylated monomers can undergo a melt polycondensation reaction with an acetic acid removal reaction. As the reaction vessel, it is preferable to use a reaction vessel equipped with monomer feed means, acetic acid discharge means, molten polyester extraction means, and stirring means. Such a reaction vessel (polycondensation apparatus) can be appropriately selected from known ones.

The melt polycondensation temperature in the first step needs to be set to 315° C. or less and is preferably 290° C. to 310° C. If this temperature is less than 290° C., there is a tendency that a prepolymer having a sufficient degree of polymerization is not obtained, and if this temperature is more than 310° C., there is a tendency that discoloration is likely to occur. The above melt polycondensation temperature is the temperature of the molten polymer, which can be detected by a thermocouple installed inside the reaction vessel.

In addition, the temperature increase rate of the melt polycondensation temperature is preferably in the range of 0.1 to 5.0° C./min. The temperature increase rate is further preferably in the range of 0.3 to 3.0° C./min. If the temperature increase rate is less than 0.1° C./min, the production efficiency decreases significantly, and if the temperature increase rate is more than 5.0° C./min, the amount of unreacted components increases, which may cause discoloration in the second step.

In this embodiment, it is preferable to, after the completion of the acetylation reaction, increase the temperature to initiate polycondensation and further increase the temperature to 290 to 315° C. as the final temperature at the temperature increase rate of 0.1° C./min to 2° C./min. It is preferable to also increase the polycondensation temperature corresponding to the melting temperature of the produced polymer increasing due to the progress of the polycondensation, in this manner.

In the polycondensation reaction, catalysts known as polycondensation catalysts for polyesters can be used. Examples of the catalysts include metal catalysts, such as magnesium acetate, stannous acetate, tetrabutyl titanate, lead acetate, sodium acetate, and potassium acetate, and organic compound catalysts, such as N-methylimidazole.

In the melt polycondensation, when the temperature of the molten polymer in the reaction vessel reaches 200° C. or more, preferably 220° C. to 315° C., the liquid crystal polyester having a low degree of polymerization is extracted from the polymerization vessel in a molten state, fed to a cooling machine, such as a steel belt or a drum cooler, and cooled and solidified.

Then, the solidified liquid crystal polyester having a low degree of polymerization is ground to a size suitable for the subsequent solid phase polycondensation reaction. The grinding method is not particularly limited, and preferable examples include methods using apparatuses such as impact type grinding machines, such as Feather Mill, Victory Mill, Kolloplex, Pulverizer, Contraplex, Scroll Mill, and ACM Pulverizer manufactured by Hosokawa Micron Corporation, and Roll Granulator, which is a cracking type grinding machine manufactured by MATSUBO Corporation. The grinding method is particularly preferably a method using Feather Mill manufactured by Hosokawa Micron Corporation. In this embodiment, although there is no particular limitation on the particle diameter of the ground product, the particle diameter is preferably in the range of passing through 4 mesh to not passing through 2000 mesh with an industrial sieve (Tyler mesh), further preferably in the range of 5 mesh to 2000 mesh (opening: 0.01 to 4 mm), and most preferably in the range of 9 mesh to 1450 mesh (opening: 0.02 to 2 mm).

In the second step according to this embodiment, the ground product (prepolymer) obtained in the above grinding step is subjected to solid phase polycondensation to obtain the target liquid crystal polyester.

There is no particular limitation on the apparatus used in the solid phase polycondensation step, and its operation conditions, and known apparatuses and methods, such as rotary kilns, can be used.

The solid phase polycondensation temperature in the second step needs to be set to 315° C. or less and is preferably 290° C. to 310° C. If this temperature is less than 290° C., there is a tendency that a liquid crystal polyester having a sufficient degree of polymerization is not easily obtained, and if this temperature is more than 310° C., there is a tendency that discoloration is likely to occur. The above solid phase polycondensation temperature is the temperature of the polymer powder, which can be detected by a thermocouple installed inside the reaction vessel.

A thermotropic liquid crystal polyester is obtained by the method in this embodiment. This can be confirmed by the following procedure. Using a polarizing microscope BH-2 manufactured by Olympus Corporation equipped with a microscope cooling and heating stage model 10002 manufactured by JAPAN HIGH TECH CO., LTD., a polyester sample is heated and melted on the microscope heating stage. At this time, by observing the polyester sample at magnifications of 100× and 200× during melting, it can be confirmed whether the polyester sample shows optical anisotropy.

The liquid crystal polyester obtained by the production method according to the present invention can be preferably used as the resin component of a resin composition for molding an LED reflector.

### EXAMPLES

The present invention will be more specifically described below with reference to Examples, but the present invention is not limited to the following Examples.

<Production of Liquid Crystal Polyesters>

First, examples of the production of liquid crystal polyesters are shown below. In addition, the monomer composition (mole %), polycondensation temperature, and melting point of each polyester produced are shown in Table 1.

### Example 1

### Production of Liquid Crystal Polyester (A)

Into a polymerization reaction vessel with an internal volume of 6 L using SUS316 as a material and having a double helical stirring blade (manufactured by Nitto Koatsu Co., Ltd.), 0.83 kg (6.0 moles) of p-hydroxybenzoic acid (manufactured by UENO FINE CHEMICALS INDUSTRY, LTD.), 0.37 kg (2.0 moles) of 4,4′-dihydroxybiphenyl (manufactured by Honshu Chemical Industry Co., Ltd.), 0.34 kg (2.0 moles) of 1,4-cyclohexanedicarboxylic acid (manufactured by Eastman Chemical Company), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

After the completion of the acetylation, the temperature of the polymerization reaction vessel in an acetic acid distillation state was increased at 0.5° C./min, and when the melt temperature in the vessel reached 310° C., the polymer was removed from the extraction port in the lower portion of the reaction vessel, and cooled and solidified. The obtained polymer was ground to a size passing through a sieve having an opening of 2.0 mm by a grinding machine manufactured by Hosokawa Micron Corporation to obtain a prepolymer.

Next, the prepolymer obtained above was charged into a solid phase polymerization apparatus (rotary kiln) manufactured by IRIE SHOKAI Co., Ltd., nitrogen was flowed at a flow rate of 0.1 Nm³/hr, and at a rotation rate of 5 rpm, the heater temperature was increased from room temperature to 190° C. over 3 hours, then increased to 280° C. over 5 hours, and further increased to 320° C. over 3 hours. The temperature was maintained to perform solid phase polycondensation. After it was confirmed that the polymer powder temperature in the kiln reached 300° C., the heating was stopped, and cooling was performed over 4 hours while the kiln was rotated. When the molten state of the polymer after the solid phase polycondensation was observed under a polarizing microscope, optical anisotropy was shown, which confirms liquid crystallinity. In this manner, about 1.5 kg of a powdery thermotropic liquid crystal polyester (A) was obtained. The melting point of the obtained thermotropic liquid crystal polyester (A) was 345° C.

### Example 2

### Production of Liquid Crystal Polyester (B)

Into a 6 L polymerization reaction vessel using SUS316 as a material and having a double helical stirring blade (manufactured by Nitto Koatsu Co., Ltd.), 1.10 kg (8.0 moles) of p-hydroxybenzoic acid (manufactured by UENO FINE CHEMICALS INDUSTRY, LTD.), 0.19 kg (1.0 mole) of 4,4′-dihydroxybiphenyl (manufactured by Honshu Chemical Industry Co., Ltd.), 0.17 kg (1.0 mole) of 1,4-cyclohexanedicarboxylic acid (manufactured by Eastman Chemical Company), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

Next, as in Example 1, a prepolymer was obtained, and then, solid phase polymerization was performed to obtain a thermotropic liquid crystal polyester (B). The melting point of the obtained thermotropic liquid crystal polyester was 342° C.

### Example 3

### Production of Liquid Crystal Polyester (C)

Into a 6 L polymerization reaction vessel using SUS316 as a material and having a double helical stirring blade (manufactured by Nitto Koatsu Co., Ltd.), 0.55 kg (4.0 moles) of p-hydroxybenzoic acid (manufactured by UENO FINE CHEMICALS INDUSTRY, LTD.), 0.56 kg (3.0 moles) of 4,4′-dihydroxybiphenyl (manufactured by Honshu Chemical Industry Co., Ltd.), 0.52 kg (3.0 moles) of 1,4-cyclohexanedicarboxylic acid (manufactured by Eastman Chemical Company), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

Next, as in Example 1, a prepolymer was obtained, and then, solid phase polymerization was performed to obtain a thermotropic liquid crystal polyester (C). The melting point of the obtained thermotropic liquid crystal polyester was 350° C.

### Example 4

### Production of Liquid Crystal Polyester (D)

Into a 6 L polymerization reaction vessel using SUS316 as a material and having a double helical stirring blade (manufactured by Nitto Koatsu Co., Ltd.), 0.83 kg (6.0 moles) of p-hydroxybenzoic acid (manufactured by UENO FINE CHEMICALS INDUSTRY, LTD.), 0.37 kg (2.0 moles) of 4,4′-dihydroxybiphenyl (manufactured by Honshu Chemical Industry Co., Ltd.), 0.29 kg (1.7 moles) of 1,4-cyclohexanedicarboxylic acid (manufactured by Eastman Chemical Company), 0.05 kg (0.3 moles) of isophthalic acid (manufactured by A.G. International), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

Next, as in Example 1, a prepolymer was obtained, and then, solid phase polymerization was performed to obtain a thermotropic liquid crystal polyester (D). The melting point of the obtained thermotropic liquid crystal polyester was 340° C.

### Example 5

### Production of Liquid Crystal Polyester (E)

Into a 6 L polymerization reaction vessel using SUS316 as a material and having a double helical stirring blade (manufactured by Nitto Koatsu Co., Ltd.), 0.55 kg (4.0 moles) of p-hydroxybenzoic acid (manufactured by UENO FINE CHEMICALS INDUSTRY, LTD.), 0.56 kg (3.0 moles) of 4,4′-dihydroxybiphenyl (manufactured by Honshu Chemical Industry Co., Ltd.), 0.03 kg (0.2 moles) of 1,4-cyclohexanedicarboxylic acid (manufactured by Eastman Chemical Company), 0.38 kg (2.3 moles) of terephthalic acid (manufactured by Mitsui Chemicals, Inc.), 0.08 kg (0.5 moles) of isophthalic acid (manufactured by A.G. International), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

Next, as in Example 1, a prepolymer was obtained, and then, solid phase polymerization was performed to obtain a thermotropic liquid crystal polyester (E). The melting point of the obtained thermotropic liquid crystal polyester was 338° C.

### Comparative Example 1

### Production of Liquid Crystal Polyester (F)

Operation until acetylation was performed as in Example 1. After the completion of the acetylation, the temperature of the polymerization reaction vessel in an acetic acid distillation state was increased at 0.5° C./min, and when the melt temperature in the vessel reached 320° C., the polymer was removed from the extraction port in the lower portion of the reaction vessel, and cooled and solidified. The obtained polymer was ground to a size passing through a sieve having an opening of 2.0 mm by a grinding machine manufactured by Hosokawa Micron Corporation to obtain a prepolymer. The prepolymer became brown.

Next, solid phase polymerization was performed as in Example 1 except that the above prepolymer was used, to obtain a thermotropic liquid crystal polyester (F). The melting point of the obtained thermotropic liquid crystal polyester was 360° C., but it was colored brown.

### Comparative Example 2

### Production of Liquid Crystal Polyester (G)

A prepolymer was obtained as in Example 1.

Next, the prepolymer obtained above was charged into a solid phase polymerization apparatus (rotary kiln) manufactured by IRIE SHOKAI Co., Ltd., nitrogen was flowed at a flow rate of 0.1 Nm³/hr, and at a rotation rate of 5 rpm, the heater temperature was increased from room temperature to 190° C. over 3 hours, then increased to 280° C. over 5 hours, and further increased to 340° C. over 4.2 hours. The temperature was maintained to perform solid phase polycondensation. After it was confirmed that the polyester powder temperature in the kiln reached 320° C., the heating was stopped, and cooling was performed over 4 hours while the kiln was rotated, to obtain about 1.5 kg of a powdery thermotropic liquid crystal polyester (G). The melting point of the obtained thermotropic liquid crystal polyester (G) was 355° C., but it was discolored brown.

### Comparative Example 3

### Production of Liquid Crystal Polyester (H)

Into a 6 L polymerization reaction vessel using SUS316 as a material and having a double helical stirring blade (manufactured by Nitto Koatsu Co., Ltd.), 0.41 kg (3.0 moles) of p-hydroxybenzoic acid (manufactured by UENO FINE CHEMICALS INDUSTRY, LTD.), 0.65 kg (3.5 moles) of 4,4′-dihydroxybiphenyl (manufactured by Honshu Chemical Industry Co., Ltd.), 0.60 kg (3.5 moles) of 1,4-cyclohexanedicarboxylic acid (manufactured by Eastman Chemical Company), 0.15 g of potassium acetate (manufactured by KISHIDA CHEMICAL Co., Ltd.) as a catalyst, and 0.50 g of magnesium acetate (manufactured by KISHIDA CHEMICAL Co., Ltd.) were charged, and pressure reduction-nitrogen injection in the polymerization reaction vessel was performed twice to perform nitrogen replacement. Then 1.07 kg (10.5 moles) of acetic anhydride was further added, the rotation rate of the stirring blade was set to 70 rpm, the temperature was increased to 150° C. over 1.5 hours, and an acetylation reaction was performed in a reflux state for 2 hours.

Next, as in Example 1, a prepolymer was obtained, and then, solid phase polymerization was performed to obtain a thermotropic liquid crystal polyester (H). The melting point of the obtained thermotropic liquid crystal polyester was 325° C.

### Comparative Example 4

### Production of Liquid Crystal Polyester (I)

Operation until acetylation was performed as in Example 1. After the completion of the acetylation, the temperature of the polymerization reaction vessel in an acetic acid distillation state was increased at 0.5° C./min, and when the melt temperature in the vessel reached 360° C., the polymer was removed from the extraction port in the lower portion of the reaction vessel, and cooled and solidified. The obtained polymer was ground to a size passing through a sieve having an opening of 2.0 mm by a grinding machine manufactured by Hosokawa Micron Corporation to obtain about 1.5 kg of a powdery thermotropic liquid crystal polyester (I). The melting point of the obtained thermotropic liquid crystal polyester (I) was 345° C., but it was discolored brown.

TABLE 1

| | | | | | | | Melt | Solid phase | |
|---|---|---|---|---|---|---|---|---|---|
| | Liquid | Monomer composition (mole %) | | | | | polycondensation | polycondensation | Melting |
| | crystal | (1) | | (2) | (3-1) | (3-2) | temperature | temperature | point |
| | polyester | CHDA | HBA | BP | IPA | TPA | (° C.) | (° C.) | (° C.) |
| Example 1 | Polyester A | 20 | 60 | 20 | — | — | 310 | 300 | 345 |
| Example 2 | Polyester B | 10 | 80 | 10 | — | — | 310 | 300 | 342 |
| Example 3 | Polyester C | 30 | 40 | 30 | — | — | 310 | 300 | 350 |
| Example 4 | Polyester D | 17 | 60 | 20 | 3 | — | 310 | 300 | 340 |
| Example 5 | Polyester E | 2 | 40 | 30 | 5 | 23 | 310 | 300 | 338 |
| Comparative | Polyester F | 20 | 60 | 20 | — | — | 320 | 300 | 360 |
| Example 1 | | | | | | | | | |
| Comparative | Polyester G | 20 | 60 | 20 | — | — | 310 | 320 | 355 |
| Example 2 | | | | | | | | | |
| Comparative | Polyester H | 35 | 30 | 35 | — | — | 310 | 300 | 325 |
| Example 3 | | | | | | | | | |
| Comparative | Polyester I | 20 | 60 | 20 | — | — | 360 | — | 345 |
| Example 4 | | | | | | | | | |

In Table 1,
CHDA represents 1,4-cyclohexanedicarboxylic acid,
HBA represents p-hydroxybenzoic acid,
BP represents 4,4′-dihydroxybiphenyl,
IPA represents isophthalic acid, and
TPA represents terephthalic acid.

The melting point of the liquid crystal polyester was measured by the following method.

### (Measurement of Melting Point)

The melting point of the liquid crystal polyester was measured by a differential scanning calorimeter (DSC) manufactured by Seiko Instruments & Electronics Ltd., using α-alumina as a reference. At this time, first, the temperature was increased from room temperature to 420° C. at a temperature increase rate of 20° C./min to completely fuse the polymer, and decreased to 150° C. at a rate of 10° C./min, and then the top of an endothermic peak obtained when the temperature was increased again to 420° C. at a rate of 20° C./min was taken as the melting point.

The optical anisotropy of the liquid crystal polyester was confirmed by the following method.

### (Confirmation of Optical Anisotropy)

Using a polarizing microscope BH-2 manufactured by Olympus Corporation equipped with a microscope cooling and heating stage model 10002 manufactured by JAPAN HIGH TECH CO., LTD., a polyester sample was heated and melted on the microscope heating stage, and observed at magnifications of 100× and 200× during melting to confirm whether the polyester sample shows optical anisotropy.

<Fabrication of Test Piece for Light Reflectance Measurement>

First, pellets of a liquid crystal polyester resin composition were fabricated by the following procedure.

With 100 parts by mass of titanium oxide particles (SR-1, manufactured by Sakai Chemical Industry Co., Ltd.), 100 Parts by mass of each of the liquid crystal polyesters (A) to (I) obtained in the above Examples and Comparative Examples was previously mixed, and the mixture was dried in an air oven at 150° C. for 2 hours. This dried mixture was fed to the hopper of a twin screw extruder (PCM-30, manufactured by Ikegai Ironworks Corp) set at a cylinder highest temperature of 370° C., and 22 parts by mass of glass fibers (PX-1, manufactured by OWENS CORNING) were further fed (side-fed) to the middle of the cylinder of the twin screw extruder. The mixture was melted and kneaded at 15 kg/hr to obtain pellets of a liquid crystal polyester resin composition.

Next, the liquid crystal polyester resin composition obtained above was injection-molded at a cylinder highest temperature of 350° C., an injection rate of 100 trim/sec, and a mold temperature of 80° C., using an injection molding machine (SG-25 manufactured by Sumitomo Heavy Industries, Ltd.), to fabricate a 13 mm (width)×130 mm (length)×3.0 mm (thickness) injection-molded body. This was used as a test piece for the measurement of light reflectance. In addition, injection molding was performed under the same conditions as the above to fabricate a flexural test piece according to ASTM D790, and it was used as a test piece for the measurement of deflection temperature under load (DTUL) and flexural modulus.

[Evaluation of Liquid Crystal Polyesters and Liquid Crystal Polyester Resin Compositions]

For the polyester powders obtained in the above Examples and Comparative Examples, the L value and light reflectance were measured by the following method. In addition, for the test pieces obtained by the above methods, light reflectance before and after a light irradiation test, deflection temperature under load, and flexural modulus were measured. The results are shown in Table 2.

### (Measurement of L Value and Light Reflectance of Polyester Powder)

The obtained thermotropic liquid crystal polyester powder was spread on a pan, and the light-emitting and light-receiving portions of a self-recording spectrophotometer (U-3500: manufactured by Hitachi, Ltd.) were pressed against the upper surface of the above powder to perform the measurement of the L value and diffuse reflectance for light having a wavelength of 480 nm. The L value is a numerical value of the Lab color system numerically expressed according to JIS Z 8729, and the light reflectance is a relative value when the diffuse reflectance of a barium sulfate standard white plate is taken as 100%. For the measured value, the average value of five measured numerical values was used.

### (Measurement of Initial Light Reflectance of Test Piece for Light Reflectance Measurement)

For the surface of the obtained test piece for light reflectance measurement, the measurement of diffuse reflectance for light having a wavelength of 480 nm was performed using a self-recording spectrophotometer (U-3500: manufactured by Hitachi, Ltd.). The Light reflectance is a relative value when the diffuse reflectance of a barium sulfate standard white plate is taken as 100%.

(Measurement of Light Reflectance after Light Irradiation Test)

A light irradiation test was performed in which the obtained test piece for light reflectance measurement was irradiated with light for 500 hours using SUNTEST XLS+ manufactured by Toyo Seiki Seisaku-sho, Ltd., by a xenon lamp with the setting of 600 W/m² and a BPT temperature of 90° C. For the surface of the test piece after this light irradiation test, the measurement of diffuse reflectance for light having a wavelength of 480 nm was performed using a self-recording spectrophotometer (U-3500: manufactured by Hitachi, Ltd.). The Light reflectance is a relative value when the diffuse reflectance of a barium sulfate standard white plate is taken as 100%.

### (Measurement of Deflection Temperature Under Load)

Using the test piece for a flexural test fabricated above, the measurement of deflection temperature under load (DTUL) was performed according to ASTM D648.

### (Measurement of Flexural Modulus)

Using the test piece for a flexural test fabricated above, the measurement of flexural modulus was performed according to ASTM D790.

TABLE 2

| | | | | | Light | | |
|---|---|---|---|---|---|---|---|
| | | Initial | | | reflectance | Deflection | |
| | | (Liquid crystal polyester | | Initial (test | after light | temperature | Flexural |
| | Liquid crystal | powder) | | piece) light | irradiation test | under load | modulus |
| | polyester | L value | Reflectance (%) | reflectance (%) | (%) | DTUL (° C.) | (GPa) |
| Example 1 | Polyester A | 79 | 41 | 86 | 86 | 245 | 7.1 |
| Example 2 | Polyester B | 77 | 40 | 87 | 84 | 240 | 8.5 |
| Example 3 | Polyester C | 80 | 41 | 83 | 83 | 235 | 6.8 |
| Example 4 | Polyester D | 79 | 42 | 86 | 85 | 250 | 9.5 |
| Example 5 | Polyester E | 80 | 40 | 86 | 80 | 245 | 10.2 |
| Comparative | polyester F | 69 | 33 | 76 | 76 | 248 | 7.5 |
| Example 1 | | | | | | | |
| Comparative | Polyester G | 68 | 30 | 72 | 72 | 243 | 7.0 |
| Example 2 | | | | | | | |
| Comparative | Polyester H | 80 | 41 | 70 | 69 | 195 | 7.0 |
| Example 3 | | | | | | | |
| Comparative | Polyester I | 55 | 20 | 60 | 60 | 220 | 5.3 |
| Example 4 | | | | | | | |

It was found that in the liquid crystal polyesters (A) to (E) of Examples 1 to 5 in which the content of 1,4-cyclohexanedicarboxylic acid (CHDA), the formula (1) component, was 2 to 30 mole % and the content of p-hydroxybenzoic acid (HBA) was in the range of 40 to 80 mole % and which were obtained by polymerization with the temperature of melt polycondensation and solid phase polycondensation set to 310° C. or less, as shown in Table 1, the L value was as large as 75 or more as shown in Table 2, the color tone was bright, and the discoloration was suppressed. The initial reflectance of these was 40% or more. In addition, it was found that all of the resin compositions obtained by using these liquid crystal polyesters were capable of being injection-molded at 380° C. or less, and as shown in Table 2, all of the initial light reflectance of the molded articles for 480 nm light was as high as 80% or more, and the light reflectance after the 500 hour light irradiation test decreased by only about 7% at most with respect to the initial light reflectance, maintaining a high level of 80% or more. In addition, no discoloration of the molded body surfaces was seen. Further, it was confirmed that all of the injection-molded bodies obtained from the resin compositions of Examples 1 to 5 had a deflection temperature under load (DTUL) of more than 220° C. and a sufficiently high flexural modulus of 6 GPa or more, and had high degrees of heat resistance and mechanical properties.

On the other hand, in the liquid crystal polyesters (F), (G), and (I) of Comparative Examples 1, 2, and 4 having the same composition as the polyester (A) but obtained by polymerization with the temperature of melt polycondensation or solid phase polycondensation being more than 315° C., as shown in Table 1, the polymers were discolored brown, and therefore, the L value decreased, and the reflectance also decreased, as shown in Table 2. In addition, the initial light reflectance of the molded articles of the resin compositions obtained by using these liquid crystal polyesters was less than 80%. In addition, in the polyester (H) in which the content of CHDA was 35 mole % and the content of HBA was 30 mole %, which were outside the ranges of the present invention, the results were that the polyester (H) was liquid crystalline, but the DTUL was less than 200° C., and the heat resistance was poor.

### INDUSTRIAL APPLICABILITY

According to the present invention, it is possible to provide a method for producing a liquid crystal polyester in which a liquid crystal polyester having sufficient heat resistance and mechanical properties and having sufficiently suppressed discoloration can be obtained.

1. A method for producing a liquid crystal polyester, comprising:
subjecting a composition in which a dicarboxylic acid compound, a hydroxycarboxylic acid compound, and a dihydroxy compound are contained to melt polycondensation, and
subjecting an obtained reaction product to solid phase polycondensation, wherein
the composition contains, based on a total of the dicarboxylic acid compound, the hydroxycarboxylic acid compound, and the dihydroxy compound, 2 to 30 mole % of a dicarboxylic acid compound represented by the following formula (1), and 40 to 80 mole % of p-hydroxybenzoic acid,
a polycondensation temperature of the melt polycondensation is 315° C. or less, and a polycondensation temperature of the solid phase polycondensation is 315° C. or less.

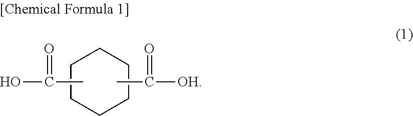

2. The method for producing a liquid crystal polyester according to claim 1, wherein the composition contains, based on the total of the dicarboxylic acid compound, the hydroxycarboxylic acid compound, and the dihydroxy compound, 10 to 30 mole % of the dicarboxylic acid compound represented by the formula (1), 40 to 80 mole % of p-hydroxybenzoic acid, and 10 to 30 mole % of an aromatic dihydroxy compound represented by the following formula (2),
[Chemical Formula 2]
HO—X—OH (2)
in the formula (2), wherein X represents a divalent group having an aromatic ring.

3. The method for producing a liquid crystal polyester according to claim 1, wherein the liquid crystal polyester contains 2 to 29 mole % of the dicarboxylic acid compound represented by the formula (1), 40 to 80 mole % of p-hydroxybenzoic acid, 10 to 30 mole % of an aromatic dihydroxy compound represented by the following formula (2), and 1 to 28 mole % of an aromatic dicarboxylic acid compound represented by the following formula (3), and contains 1 mole % or more of isophthalic acid as the aromatic dicarboxylic acid compound represented by the formula (3),
[Chemical Formula 3]
HO—X—OH (2)
in the formula (2), wherein X represents a divalent group having an aromatic ring, 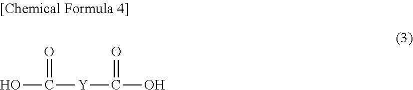
in the formula (3), wherein Y represents a divalent group having an aromatic ring.
